(19) United States
(12) Patent Application Publication
(10) Pub. No.: US 2011/0146610 A1
(43) Pub. Date: Jun. 23, 2011

(54) Handheld work apparatus

(75) Inventors: Mark Reichler, Remshalden (DE); Klaus-Martin Uhl, Plochingen (DE)

(73) Assignee: Andreas Stihl AG & Co. KG.

(21) Appl. No.: 12/926,608

(22) Filed: Nov. 30, 2010

(30) Foreign Application Priority Data
Dec. 17, 2009 (DE) 10 2009 060 973.3

(51) Int. Cl. F02N 11/00

(52) U.S. Cl. 123/179.28

(57) ABSTRACT

A handheld work apparatus having an internal combustion engine and an ignition is equipped with a start device for the engine. The start device includes an electric motor and, for driving the electric motor, a battery (10) is provided which is connected to the electric motor via a switching device. For simplifying the arrangement and for safe handling, a common operator-controlled element for switching on the ignition and for activating the start device is provided which can at least be set to a stop position (0), an operating position (I) and a start position, whereby the operating position (I) is between the stop position (0) and the start position.

### CROSS REFERENCE TO RELATED APPLICATION

This application claims priority of German patent application no. 10 2009 060 973.3, filed Dec. 17, 2009, the entire content of which is incorporated herein by reference.

### FIELD OF THE INVENTION

The invention relates to a handheld work apparatus having a combustion engine.

### BACKGROUND OF THE INVENTION

A pull-cord operated arrangement is generally used to start internal combustion engines in handheld work apparatuses. In U.S. Pat. No. 6,758,181, it was also suggested to provide a starter having a buffer/energy storage unit which is arranged midway along an energy transmission system between a drive element and a driven element. In this connection, the buffer/energy storage unit is to be able to store the power supplied by the driving process during the driving process of the drive element. The drive element is an electric motor which serves as a driving power source. Furthermore, a starter device for internal combustion engines of small single-cylinder units is known from DE 42 15 509 A1, in which connection the starter device includes an electric motor as a starter motor, a reduction gear to reduce the starting speed and an intermediate shaft having a pitch thread. Furthermore, a pinion, whose inner diameter has a pitch thread coating with the pitch thread on the intermediate shaft, is provided. Furthermore, a flywheel of the internal combustion engine to be started is provided. The flywheel has a sprocket on the outer diameter, in which the pinion of the intermediate shaft becomes engaged during the starting procedure. In the gear drive between the electric motor and the flywheel, which results from the engaging of the pinion, a torsionally flexible member is arranged on the force flow path. This member is configured as a spring-loaded accumulator.

Actuation of such starting devices is generally effected by a switch specifically provided for this purpose. When actuating such a contact, for example, designed as an electric switch or pushbutton, the electric motor is activated. The adjustment of the flaps in the carburetor and also the activation of the ignition are effected by other operator-controlled elements such as are known for handheld work apparatuses driven by a internal combustion engine. This may lead to operator errors.

### SUMMARY OF THE INVENTION

It is an object of the present invention to provide a handheld work apparatus of the above type, in which the number of operator-controlled elements required is reduced and the operation of the apparatus is simplified.

The handheld work apparatus of the invention includes: a combustion engine; an ignition; a start device for the combustion engine; the start device including an electric motor and a battery to drive the electric motor; a switch device for connecting the battery to the electric motor; a common operator-controlled element for enabling the ignition and for activating the start device; the common operator-controlled element being capable of being set to a stop position (0), an operating position (I) and a start position; and, the operating position (I) being between the stop position (0) and the start position.

The combination of the ignition and fuel supply functions as well as the start procedure in one operator-controlled element leads to a simplification of the construction and a reduction of the number of required individual parts. This also leads to a reduction of the manufacturing and assembly costs. Furthermore, in this manner, the functions can be tuned to one another so that operating errors do not occur.

According to a preferred embodiment, an operator-controlled lever mounted on a single-lever shaft is provided as an operator-controlled element. Such mounting via a single-lever shaft is constructively simple and actuation of the operator-controlled lever supported thereon poses no problem. Preferably, the operator-controlled lever with the single-lever shaft is arranged on an engine housing in the area next to a rear handle. Thereby, it is possible to actuate the operator-controlled lever, without removing from the handle the operator's hand holding the rear handle.

Since the stop-position and the operating position are held for an extended period of time, it is advantageous that the operating lever is held in a latched manner in both the stop-position and the operating position. Of course, it is also possible that the stop position is subject to touching or a combination of latching and touching modes. In the start position of the operator-controlled lever, a choke flap can be fixed in a latching manner for the starting of the drive motor, and by actuation of a throttle lever during the operation of the drive motor, the choke flap is reset. It is practical that with respect to the start position, the operator-controlled lever is configured as a touching lever and is automatically returned to the operating position upon releasing the touching lever. Thereby, it is ensured that the operator-controlled lever does not remain in the start position any longer than required to activate the starter device. Alternatively, the start position of the operator-controlled lever can be configured to be latched. In the stop position of the operator-controlled lever, the ignition is preferably switched off and a sparking contact bypassing the ignition is closed.

In the operating position and the start position, the ignition and the engine control unit for the combustion engine are advantageously switched on. In the operating position and the start position; a device for supplying fuel, which for example is realized via a valve control, is also activated. To avoid an unwanted initiation of the start procedure, it is considered to be practical that up until the activation of the start device, the operator-controlled lever is held in the start position for a predetermined period of time. The period of time is preferably between a few milliseconds and about 3 seconds. Thus, it is ensured that a start process is initiated only when the operator-controlled lever is held in the start position during the aforementioned time period.

At the same time, a throttle flap and a choke flap are preferably actuated via the operator-controlled lever in dependence on the position of the operator-controlled lever. The operator-controlled lever acts upon the throttle flap or the choke flap via control elements. In a further embodiment, the carburetor is equipped with an injection valve. By means of the operator-controlled lever, the throttle flap is set via an electro-mechanical actuator or an additional air passage is opened in the carburetor. For the start process, it is practical that, in the start position, the throttle flap is set open and the choke flap is closed or not completely closed. Thereby, the enriched mixture required for the starting of the combustion engine is provided.

In order to avoid that the internal combustion engine is revved up to high revolutions per minute right after the starting of the internal combustion engine, it is practical to provide a blocking device which allows for an activation of the start device only upon effectively actuating a blocking lever. Such a blocking device can be mechanical or electro-mechanical and is provided in addition to other blocking arrangements. For example, the throttle flap can be blocked in the set position.

In a constructive embodiment, it has turned out to be practical to arrange the operator-controlled lever comprising the single-lever shaft in the engine housing in such a manner that, with respect to the stop position, the angle of rotation of the operator-controlled lever is about 30° relative to the operating position and about 55° relative to the start position. To determine whether the capacity of the battery is still sufficient for the start process, it is practical to provide a charge status indicator for the charge status of the battery which can be switched on as needed. In a particular embodiment, it is provided that the charge status indicator can be switched on by means of actuating the operator-controlled lever into the start position. In this manner, the charge status is displayed in the time period in which the operator-controlled lever must be held in the start position until the start process is initiated. The charge status indicator is expediently arranged on a battery pack which can be inserted into an accommodating housing.

### BRIEF DESCRIPTION OF THE DRAWINGS

The invention will now be described with reference to the drawings wherein:

FIG. 1 shows a motor-driven chain saw having an electric starter and an operator-controlled lever with a single-lever shaft;

FIG. 2 is an enlarged view of a section of the motor-driven chain saw in the area of the operator-controlled lever with the operator-controlled lever positions;

FIG. 3 is a schematic view of the operator-controlled lever positions;

FIG. 4 shows a functional principle of the electric-start system; and,

FIG. 5 is a schematic view of an electro-mechanical control of a carburetor.

### DESCRIPTION OF THE PREFERRED EMBODIMENTS OF THE INVENTION

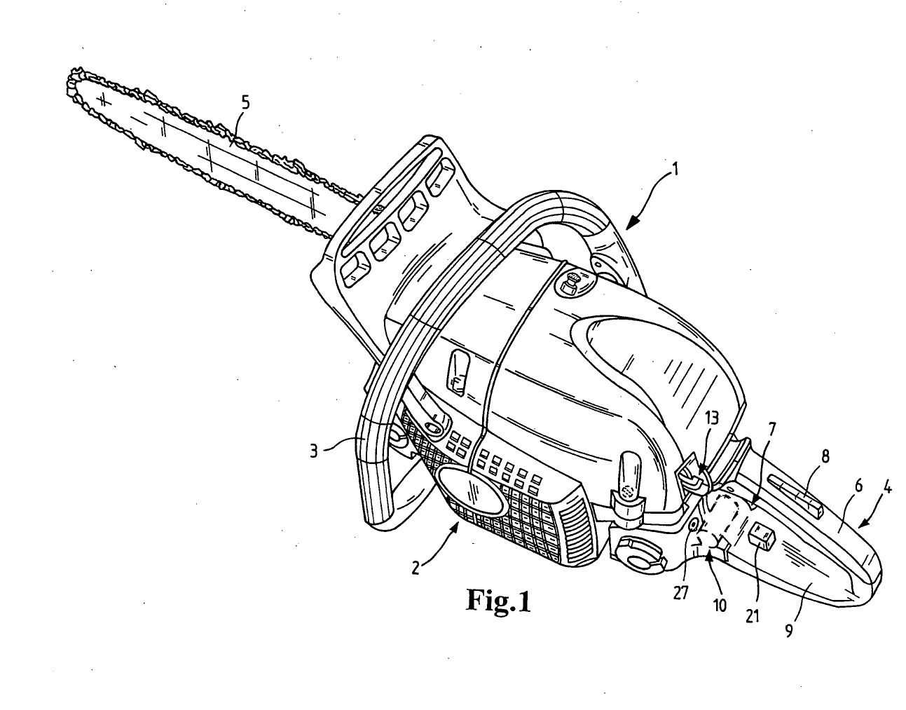

FIG. 1 shows a motor-driven chain saw 1 having a saw-chain guide bar 5 projecting out of an engine housing 2 and a front handle arranged on the engine housing 2 and a rear handle 4 to guide the motor-driven chain saw 1. The engine housing 2 includes a start device which will be described in more detail below and includes an electric motor. The rear handle 4 has an upper grip area 6 in which a throttle lever 7 and a blocking lever 8 are mounted. In addition, the rear handle 4 has a lower grip area 9 which is configured as an accommodating housing 11 for a battery pack 10. The battery pack 10 is provided with a charge status indicator, for example in the form of a luminous device 27. Furthermore, a control unit for the start process is situated in the lower grip area 9, which unit will be described in more detail below.

An operator-controlled lever 13, which is configured as an operator-controlled lever capable of pivoting on a single-lever shaft, is arranged adjacent to the rear handle 4 on the engine housing 2. Of course, differently configured and/or movable operator-controlled elements are also options. It is, however, of importance that the operator-controlled lever 13 can assume three positions, namely for shutdown, for operating and for the starting of the combustion engine. The position for operating the internal combustion engine is between the positions for shutdown and starting of the combustion engine.

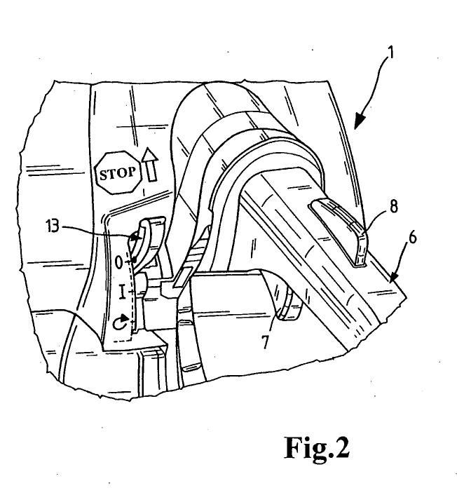

FIG. 2 shows an enlarged section of the motor-driven chain saw 1 in the area of the operator-controlled lever 13 and the rear handle. It can be seen that the operator-controlled lever 13, which is pivotally mounted in the engine housing 2, can be set to three positions “0”, “I” and “Start”. The arrow symbol rotating clockwise represents the start position. The position “0” represents “off/service”, that is, the ignition is switched off. The operator-controlled lever 13 can be mechanically connected to the throttle flap and the choke flap of a carburetor. Alternatively, however, also electro-mechanical actuating means may be considered. However, it is relevant that in the position “0” the throttle flap is closed and the choke flap is open.

The position “I” means “operation”, whereby the ignition is switched on and the throttle flap is controlled dependent on the operator and the choke flap is open. In the position of the rotating arrow, which means “start”, the start process is initiated, whereby the ignition is switched on, the throttle flap is open, and the choke flap is closed or nearly closed, and an electric signal is delivered to a control unit, which controls the procedure of the starting process for the drive motor of the motor-driven chain saw. For safety reasons, it may be provided that the electric signal is delivered to the control unit and the start process is continued only when a corresponding blocking device for the throttle lever is activated and it is thereby ensured that no actuation of the throttle lever 7 occurs during the starting process.

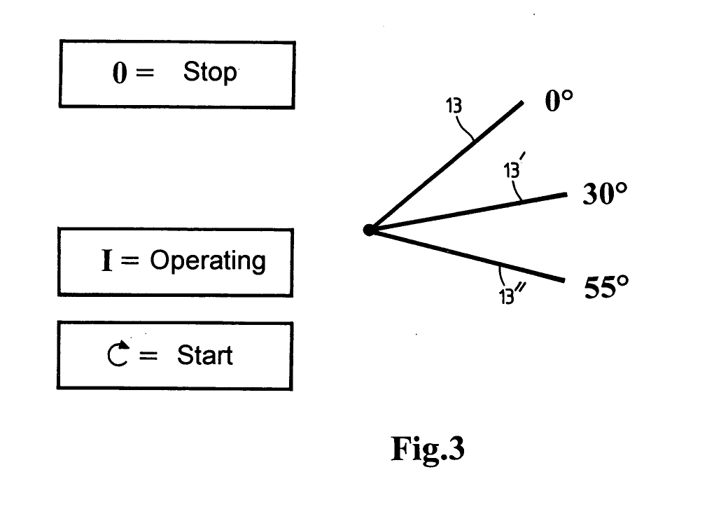

FIG. 3 shows a schematic view of the operator-controlled lever positions, whereby the operator-controlled lever 13 is mounted on a single-lever shaft 14 and is pivotal about the rotational axis thereof. In its uppermost position “0”, the operator-controlled lever 13 is in the stop position at an angular position of 0°. This can, for example, pertain to a latching position, that is to say the operator-controlled lever 13 remains in this position until an actuating force acts thereon. From the position “0”, the operator-controlled lever can be pivoted downward about the rotational axis of the single-lever shaft 14. As shown in the embodiment, the operator-controlled lever 13′ is set to “operating” in the position “I” at an angle of 30°. This is also a latching position. From the position “I”, the operator-controlled lever 13 can be pivoted upwards, in which connection the position “0” is initially triggered upon momentary action, with further pivoting the operator-controlled lever 13 finally remains in the latching position “0”.

From the position “I”, the operator-controlled lever can be pivoted further downward into the position of the rotating arrow with which the start process of the engine can be initiated. In FIG. 3 the operator-controlled lever 13″ assumes a position which is pivoted by an angle of 55° from the position “0”. The start position is a position subject to momentary action, that is to say the operator-controlled lever 13″ remains in this position only as long as a corresponding actuation by the operator holds the operator-controlled lever 13″ in this position. Thereafter, it returns to the operating position “I” by the force of a return spring, as is indicated by the reference sign 13′.

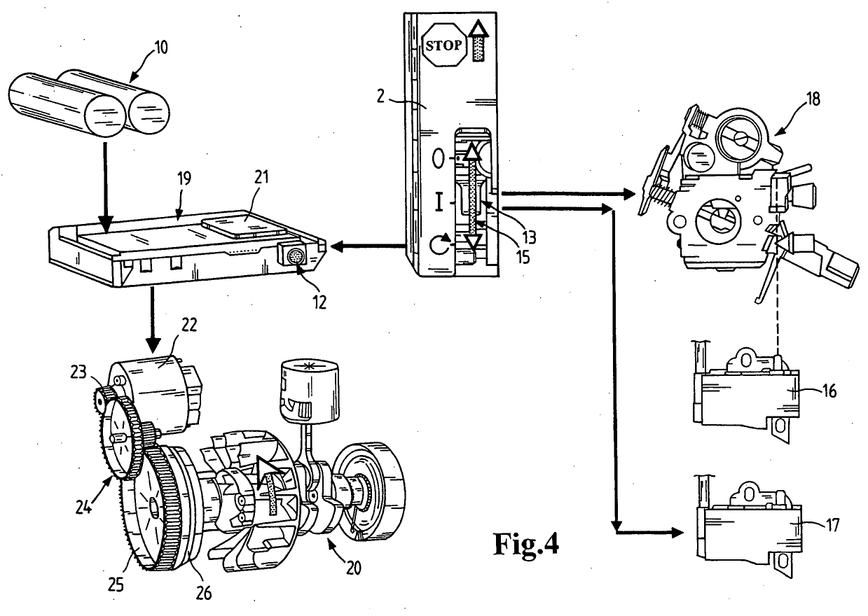

FIG. 4 shows the functional principle of the electric start system for the motor-driven chain saw 1 shown in FIG. 1. The operator-controlled lever 13 fixed on the single-lever shaft is situated in the shown section of the motor housing 2. The operator-controlled lever 13 can be moved upward and downward according to arrow 15, and according to the embodiment can assume three positions “0”, “I”, and “ [symbol] ”. As already described with respect to FIG. 2, the throttle flap and choke flap of the carburetor 18 are acted upon corresponding to the position of the operator-controlled lever. For this purpose, a rod assembly, not shown in FIG. 4, can be provided. Alternatively, electro-mechanical positioning devices, which are controlled by the signals generated by the operator-controlled lever 13, are possible. If no electronic support of the choke actuation occurs, it is called a softchoke. When actuating via a rod assembly, the choke flap is reopened when the operator-controlled lever 13 is released, since it is reset to the operating position. In the position “0”, the ignition is switched off, that is a device 16 for the fuel supply and valve control as well as an engine control unit 17 are switched off. The valve control can take place via an M-Tronik. In such a control, an electronic alignment between the start conditions and the state of the machine is possible. In the position “I” of the operator-controlled lever 13, the ignition is switched on, and the device 16 for fuel supply and the valve control as well as the engine control unit 17 are thus activated.

By pushing the operator-controlled lever 13 downward and into the start position, an electric contact is closed and thus an electric signal is supplied to a control unit 19 in order to initiate the starting of a drive motor 20 of the motor-driven chain saw. The control unit 19 is attached to the battery pack 10 and is preferably equipped with a key 21 for a charge status indicator 12. The control unit 19 serves to control an electric motor 22 on whose shaft a pinion 23 is mounted, which is engaged with a spur gear 24. At the output end, the spur gear 24 is engaged with a cogwheel 25 which is fixed on a wall of a spring housing 26. A spiral spring (not shown) is arranged in the spring housing 26. At its radial outer end, the spiral spring is fixedly connected to the spring housing 26 and, with its radially inner end, it is coupled to the crankshaft of the drive motor 20 in such a manner that upon release of the spiral spring the crankshaft is caused to rotate. Thus, the spiral spring fulfills the function of a spring-loaded accumulator.

As described above, to start the drive motor 20, the operator-controlled lever 13 is moved into the start position and is held there for a predetermined period of time, whereby this period of time is between 0.05 seconds and 3 seconds. In this manner, it is determined that an intended start is to take place. Coincidental short actuation of the operator-controlled lever 13 is recognized as an accidental or inadvertent touching. During the predetermined period of time, for instance, the charge status of the battery pack 10 can be indicated with the help of a charge status indicator 12. This indicator can also be activated via the key 21 on the control unit 19. If, upon actuating the operator-controlled lever into the start position, it is recognized that the internal combustion engine is running (revolutions-per-minute recognition) no start process will be initiated.

After the predetermined period of time of, for example, 3 seconds for the actuation of the operator-controlled lever 13 into the start position, the control unit 19 switches the electric motor 22 to the battery pack 10. When the internal combustion engine is running the operator-controlled lever 13 is released, whereby the latter returns to the operating setting in position “I” due to the return spring. The electricity from the battery pack 10 drives the electric motor 22 whereby the pinion 23 rotates. The pinion 23, in turn, rotates via the reducing spur gear 24, the cogwheel 25 and therewith rotates the spring housing 26 on which spring housing 26 the radial outer end of the spiral spring is fixed. This rotation of the spring housing 26 causes a tensioning of the spiral spring until a predetermined spring force is reached. During the tensioning of the spiral spring, rotation of the inner shaft on which the inner end of the spiral spring is fixed and rotation of the crankshaft of the drive motor 20, which can be coupled to the inner shaft, are prevented.

The inner shaft is not released until the spiral spring has sufficient tension force to rotate the crankshaft of the drive motor 20 in such a manner that a starting of the drive engine is possible, so that the crankshaft is rotated fast enough via a cam to generate an ignition sequence during a controlled fuel supply, which causes the starting of the drive motor 20. As described above, the throttle lever blocking device can be provided as a safety measure. The throttle lever blocking device interrupts a contact between the electrical line and the engine control unit 17, so that it is ensured that any unintentional start process by simply pressing the operator-controlled lever 13 is avoided. By means of an additional latching mechanism, the throttle flap can be fixed in the start position, so that the throttle lever 7 (see FIGS. 1 and 2) cannot be actuated by the operator during the starting of the drive motor and, thereby, a predefined amount of fuel is not exceeded.

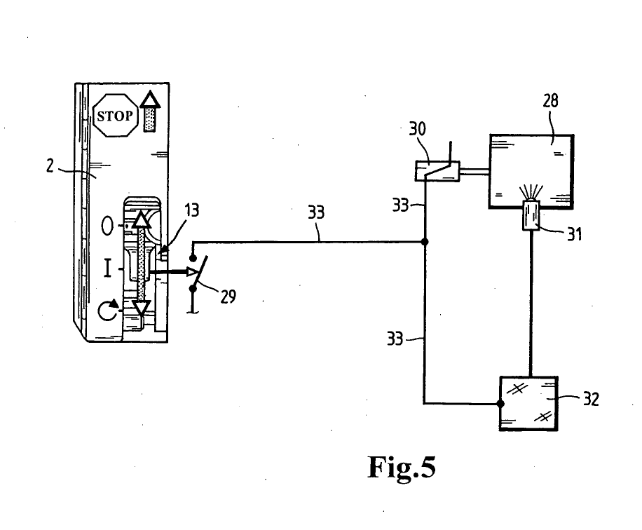

FIG. 5 shows the operator-controlled lever 13 in the motor housing 2. In the position “I”, the operator-controlled lever 13 closes an electric switch 29 which is connected to an electro-mechanical actuator 30 and an engine control unit 32 via electrical connecting lines 33. When the switch 29 is closed, the electro-mechanical actuator 30 brings the carburetor 28 into the start position and the engine control unit is activated, whereby an injection valve 31 in the carburetor 28 is also controlled. No choke flap is required in such a carburetor. A device according to FIG. 5 can be provided as an alternative to the mechanical control of the flaps in the carburetor shown in FIG. 4. The rest of the start device remains unchanged.

Via a further signal delivered to the charge status indicator, which is additionally generated either by the operator-controlled lever 13 or by the key 21, as previously described with respect to FIG. 4, an optical signal is conveyed to a luminous device 27 (FIG. 1). The luminous device can include multiple fields, as in the shown embodiment, a central circular area and bands arranged radially thereto. Thereby, the charge status can be indicated by colors or also by a flash sequence, for example, by the fluorescent color of green and/or a continuous light for a fully charged battery, by the fluorescent color of orange and/or slow flashing for impending charging of the battery, and by the fluorescent color of red and/or flashing at short impulses for an empty battery.

It is understood that the foregoing description is that of the preferred embodiments of the invention and that various changes and modifications may be made thereto without departing from the spirit and scope of the invention as defined in the appended claims.

What is claimed is:

1. A handheld work apparatus comprising:
a combustion engine;
an ignition;
a start device for said combustion engine;
said start device including an electric motor and a battery to drive said electric motor;
a switch device for connecting said battery to said electric motor;
a common operator-controlled element for enabling said ignition and for activating said start device;
said common operator-controlled element being capable of being set to a stop position (0), an operating position (I) and a start position; and,
said operating position (I) being between said stop position (0) and said start position.

2. The work apparatus of claim 1, further comprising a fuel preparation device configured to be set with the activation of said start device.

3. The work apparatus of claim 2, said fuel preparation device comprising a carburetor having flaps configured to be driven mechanically.

4. The work apparatus of claim 2, said fuel preparation device comprising a throttle flap and an injection valve; and, said injection valve and said throttle flap being configured to be driven electrically.

5. The work apparatus of claim 1, wherein said operator-controlled element is an operator-controlled lever mounted on a single-lever shaft.

6. The work apparatus of claim 5, further comprising:
a motor housing;
a back handle; and,
said operator-controlled lever with said single-lever shaft being mounted on said motor housing adjacent to said back handle.

7. The work apparatus of claim 5, wherein said operator-controlled lever is configured to be latchingly held in each of said stop position (0) and said operating position (I).

8. The work apparatus of claim 7, wherein a combined touch and latching stop position is provided for said operator-controlled lever.

9. The work apparatus of claim 7, further comprising:
a throttle lever;
a fuel preparation device including a choke flap;
said choke flap being latchingly fixed when said operator-controlled lever is in said start position; and,
said choke flap being reset by actuation of said throttle lever during operation of said drive motor.

10. The work apparatus of claim 5, wherein said operator-controlled lever is configured as a touch lever in relation to said start position; and,
said operator-controlled lever is configured to automatically return to said operating position (I).

11. The work apparatus of claim 5, further comprising a short circuit contact; and, wherein said ignition is switched off and said short circuit contact is closed when said operator-controlled lever is in said stop position (0).

12. The work apparatus of claim 5, further comprising an engine control unit for said combustion engine; and, wherein said ignition and said engine control unit are switched on in said operating position (I) and said start position.

13. The work apparatus of claim 10, wherein said operator-controlled lever is held in said start position for a predetermined period of time until said start device is activated; and,
said predetermined period of time is between about 0.05 seconds and 3 seconds.

14. The work apparatus of claim 5, further comprising:
a carburetor having a choke flap and a throttle flap;
control elements; and,
said operator-controlled lever acts on said throttle flap or said choke flap via said control elements in dependence on the position of said operator-controlled lever.

15. The work apparatus of claim 14, further comprising:
an electric-mechanical actuator;
said carburetor having an additional air path and an injection valve; and,
said carburetor being configured to control said throttle flap or open said additional air path in said carburetor with said operator-controlled lever via said electric-mechanical actuator.

16. The work apparatus of claim 1, further comprising:
a second switch device;
a throttle lever; and,
a blocking device configured to allow an activation of said start device only when said blocking device is effectively actuated for said throttle lever by actuating said second switch device.

17. The work apparatus of claim 5, wherein said operator-controlled lever is rotatable through a rotation angle; and,
said rotation angle to said operating position (I) is about 30° relative to said stop position (0) and said rotation angle to said start position is about 55° relative to said stop position (0).

18. The work apparatus of claim 2, further comprising:
a charge status indicator for indicating the charge status of said battery; and,
said charge status indicator being configured to be switched on as needed.

19. The work apparatus of claim 18, wherein said common operator-controlled element is an operator-controlled lever; and, said charge status indicator is switched on by the actuation of said operator-controlled lever into said start position.

20. The work apparatus of claim 18, wherein said charge status indicator includes an illuminating device configured to provide an optical signal which can be a colored optical signal or an optical signal changing as a function of time.

21. The work apparatus of claim 1, wherein said start device comprises a gear assembly and a spring-loaded accumulator.
